(19) United States
(12) Patent Application Publication
(10) Pub. No.: US 2013/0157243 A1
(43) Pub. Date: Jun. 20, 2013

(54) Systems and Methods for Obtaining Prioritized User Input

(71) Applicant: United Capital Financial Advisers, LLC, Newport Beach, CA (US)

(72) Inventors: Joseph J. Duran, Laguna Beach, CA (US); Michael S. Duncan, Bronxville, NY (US); Mark A. Ciucci, Wolverine Lake, MI (US); Leslie G. Dunham, Irvine, CA (US)

(73) Assignee: United Capital Financial Advisers, LLC, Newport Beach, CA (US)

(21) Appl. No.: 13/690,854

(22) Filed: Nov. 30, 2012

Related U.S. Application Data
(60) Provisional application No. 61/576,107, filed on Dec. 15, 2011.

(51) Int. Cl. G09B 3/00

(52) U.S. Cl. CPC G09B 3/00
USPC 434/322

(57) ABSTRACT

According to the invention, a system for receiving input from a user or users, the input indicating the relative priorities of different concerns is disclosed. The system may include at least two interfaces. The first interface may display a plurality of categories of concerns and receive a selection of one of the categories and then display a plurality of concerns associated with the selected category. Selection and prioritization of these concerns may be received for each category. A second interface may display the top priority concern of each category and allow selection from these top priority concerns an overall top priority concern. The second interface may allow the user to then select a second overall top priority concern from the remaining top priority concern of each category. The process may repeat to produce an overall priority of any number of concerns across all categories.

### CROSS-REFERENCE TO RELATED APPLICATIONS

This application claims priority to Provisional U.S. Patent Application No. 61/576,107 filed Dec. 15, 2011, entitled “SYSTEM AND METHOD FOR CLIENT INTERACTION,” the entire disclosure of which is hereby incorporated by reference, for all purposes, as if fully set forth herein.

### BACKGROUND OF THE INVENTION

This invention relates generally to adviser/client interactions. More specifically the invention relates to assisting clients in various fields, including financial and retirement consulting, in determining what their short and/or long term priorities are, and communicating them to an adviser or other third party who may further assist in determining the significance of each priority and actions that can be taken with respect thereto.

### BRIEF DESCRIPTION OF THE INVENTION

In certain embodiments, a system for receiving input from a user or users, where the input indicates the relative priorities of different concerns, is provided. The system may include a plurality of interfaces. For example, in some embodiments the system may include six interfaces. A first interface may display to a first user a plurality of categories of concerns. In one example, these categories may include “fears,” “commitments,” and “happiness.” The first interface may receive from the first user a selection of one of the categories and then display a plurality of concerns associated with the selected category. The first interface may then receive from the first user a selection of one or more of the concerns and allow the first user to input a priority of these concerns from most important to least important. The first interface may allow the first user to select the remaining categories and repeat the process of selecting and prioritizing for each category. A second interface may display to the first user the top priority concern of each category and allow the first user to select from these top priority concerns an overall top priority concern. The second interface may allow the first user to then select a second overall top priority concern from the remaining top priority concerns of each category. The process may repeat to produce an overall priority of any number of concerns across all categories. A third interface and a fourth interface may repeat the processes of the first interface and the second interface, respectively, for a second user. A fifth interface may allow either user, or someone on their behalf such as a third party/adviser, to input notes regarding their selected overall priority concerns. A sixth interface may allow the users to see both of their selected overall priority concerns and together collaborate to produce a jointly assembled overall priority listing of concerns. In other embodiments, the system may be modified to include more or fewer interfaces and/or to accommodate inputs from any number of users.

In other embodiments, a non-transitory machine readable medium with instructions stored thereon is provided. The instructions may be executable by one or more processors to (a) display, to a first user, a plurality of categories; (b) receive, from the first user, a selection of a particular category of the plurality of categories; (c) display, to the first user, in response to the selection of the particular category, a plurality of statements associated with the particular category; (d) receive, from the first user, a selection of at least one of the plurality of statements associated with the particular category; (e) receive, from the first user, a prioritization of the selected at least one of the plurality of statements associated with the particular category if more than one was selected; (f) repeat steps (b), (c), (d), and (e) for each of the plurality of categories; (g) display, to the first user, the selected statements in each category in order of priority; and (h) receive, from the first user, a prioritization of the selected statements. The instructions may further be executable to (i) repeat the above process for a second user or any number of additional users. The instruction may further be executable to (j) display the selected statements of the first user in order of priority and the selected statements of the second user and any additional users in order of priority; and (k) receive a prioritization of at least one of the selected statements of the first user and at least one of the selected statements of the second user, as well those from any additional users, to produce a jointly assembled overall priority listing.

In still other embodiments, a method of using physical cards having potential participant concerns reproduced thereon to identify and prioritize the concerns of at least one participant is provided. The method may be a physically enacted version of the above hardware implemented methods. This embodiment may include providing a plurality of cards, where each of the plurality of cards is characterized by a category and each of the plurality of cards has a potential participant concern reproduced thereon that is associated with the category of the particular card. The method may also include the first participant arranging the cards in each category from highest actual priority concern of the first participant to lowest actual priority concern of the first participant. The method may further include the first participant selecting a card having a top overall actual priority concern from the highest actual priority concern in each category. The method may additionally include the first participant repeating, at least once, the previous step from the remaining cards having a highest actual priority concern in each category to produce an ordered selection of cards having an overall priority of concerns across all categories. This process may also be repeated by a second participant or any number of additional participants. All participants may then select from the prioritized cards of each participant to create an overall prioritization order of cards.

In yet another embodiment, a deck of cards is provided. Each of the cards may have the same generally rectangular shape and size. Each card may also have a first side and a second side, where the first side of each card may include indicia thereon representative of a category. A plurality of categories may be represented in the deck of cards. A second side of each card may include indicia thereon which includes a statement, where each statement on a second side of a particular card is associated with the category indicated on the first side of the particular card. The plurality of categories may, in some embodiments, include the following categories: “Fears”, “Commitments”, and “Happiness”. The plurality of cards having the indicia representative of the “Fears” category on the first side may, in some embodiments, include cards have the following statements on their respective second sides: “Income security/safety net”, “Not being a burden to my family”, “Prepare for the unexpected”, “Protect my family if I'm not around”, and “Protect my lifestyle”. The plurality of cards having the indicia representative of the “Commitments” category on the first side may, in some embodiments, include cards have the following statements on their respective second sides: “Educate those I care about”, “Minimize taxes”, “Provide a lasting legacy”, “Support my charitable causes”, and “Support other family members”. The plurality of cards having the indicia representative of the “Happiness” category on the first side may, in some embodiments, include cards have the following statements on their respective second sides: “Grow as a person and expand my passions”, “Improve/maintain health and wellness”, “Make work optional/retirement”, “Spend guilt-free”, and “Spend time with the people I care about”.

### BRIEF DESCRIPTION OF THE DRAWINGS

The present invention is described in conjunction with the appended figures:

FIGS. 1-5 are views of an exemplary first interface used in certain embodiments of the invention for receiving user selection and prioritization of different concerns/statements in each of multiple categories;

FIGS. 6-8 are views of an exemplary second interface used in certain embodiments of the invention for receiving user selection and prioritization of different concerns/statements across all of the multiple categories;

FIGS. 9 & 10 are views of an exemplary third interface used in certain embodiments of the invention for receiving user notes regarding the selected and prioritized concerns/statements from the second interface;

FIGS. 11-13 are views of another exemplary interface used in certain embodiments of the invention for collectively prioritizing concerns/statements previously selected and prioritized by two different users;

FIG. 14 is a view of another exemplary interface used in certain embodiments of the invention for displaying information associated with selected and prioritized concerns/statements, including notes and answers to questions pertaining to each; and

FIG. 15 is a block diagram of an exemplary computer system capable of being used in at least some portion of the systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosed inventions. Rather, the ensuing description of the exemplary embodiments will provide those skilled in the art with an enabling description for implementing one or more exemplary embodiments. Various changes may be made in the function and arrangement of elements disclosed in connection with the different embodiments without departing from the spirit and scope of the invention as set forth in the appended claims. Specific details are given in the following description to provide a thorough understanding of various embodiments. However, it will be understood by one of ordinary skill in the art that any particular embodiment may be practiced with or without a specific detail discussed with regard to that embodiment or other embodiments.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments (i.e., instructions) to perform the necessary tasks may be stored in a machine readable medium. A processor(s) may execute the code to perform or cause the performance of the necessary tasks.

In one embodiment, a system for receiving input from a user or users, the input indicating the relative priorities of different concerns is provided. The system may include multiple interfaces. These interactive interfaces may be produced for the user or users on a computerized (e.g., processor-driven) device, including for example, a desktop, laptop, or notebook computer, or a mobile device such as a tablet, smart phone or the like. By way of example, these or other devices may produce the interfaces through execution of software applications and/or by rendering remotely accessed web pages.

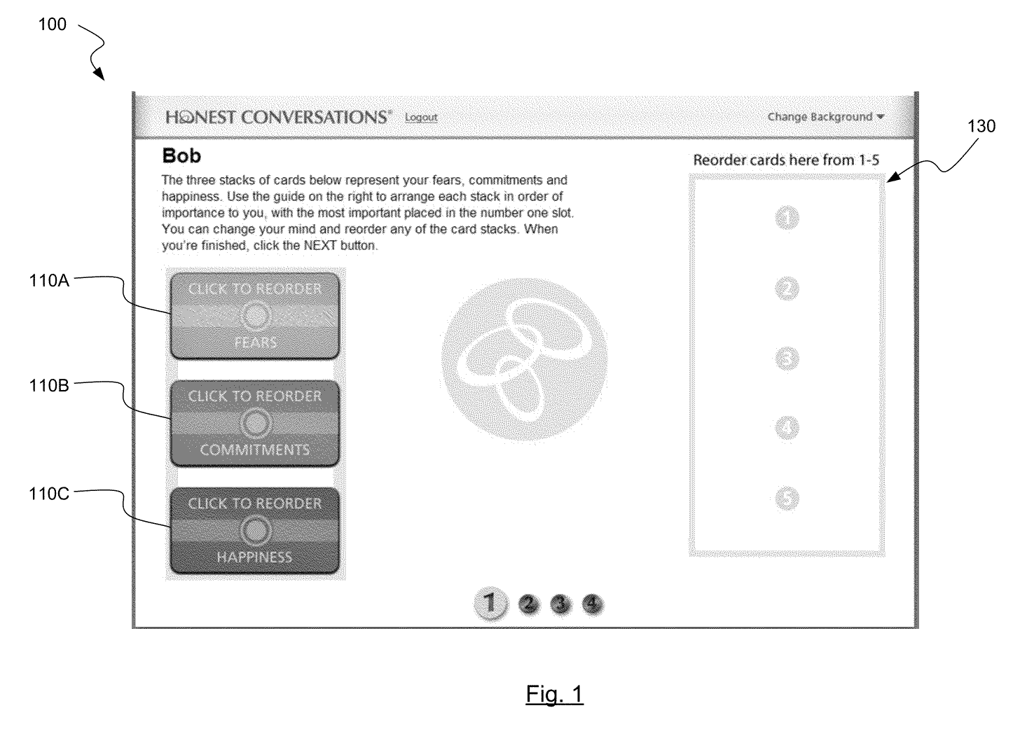

In some embodiments, a first interface may display to a first user a plurality of categories of concerns. While we will refer to “concerns” with regard to the exemplary embodiments specifically discussed herein, in other embodiments such concerns may be replaced by topics, subjects, phrases, messages, declarations, proclamations, statements, or any other possible information. FIG. 1 shows an example of a first interface 100. In this example, the categories 110 may include the titles of “fears” 110A, “commitments” 110B, and “happiness” 110C. In other embodiments, any number of categories 110 may be present and have these or other titles.

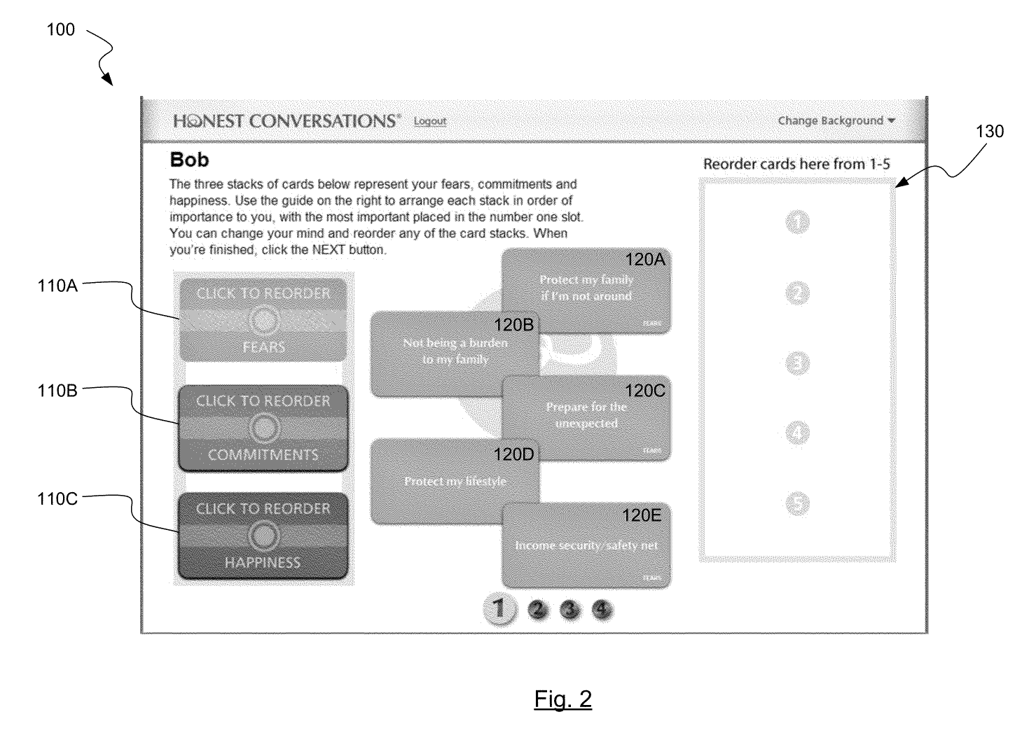

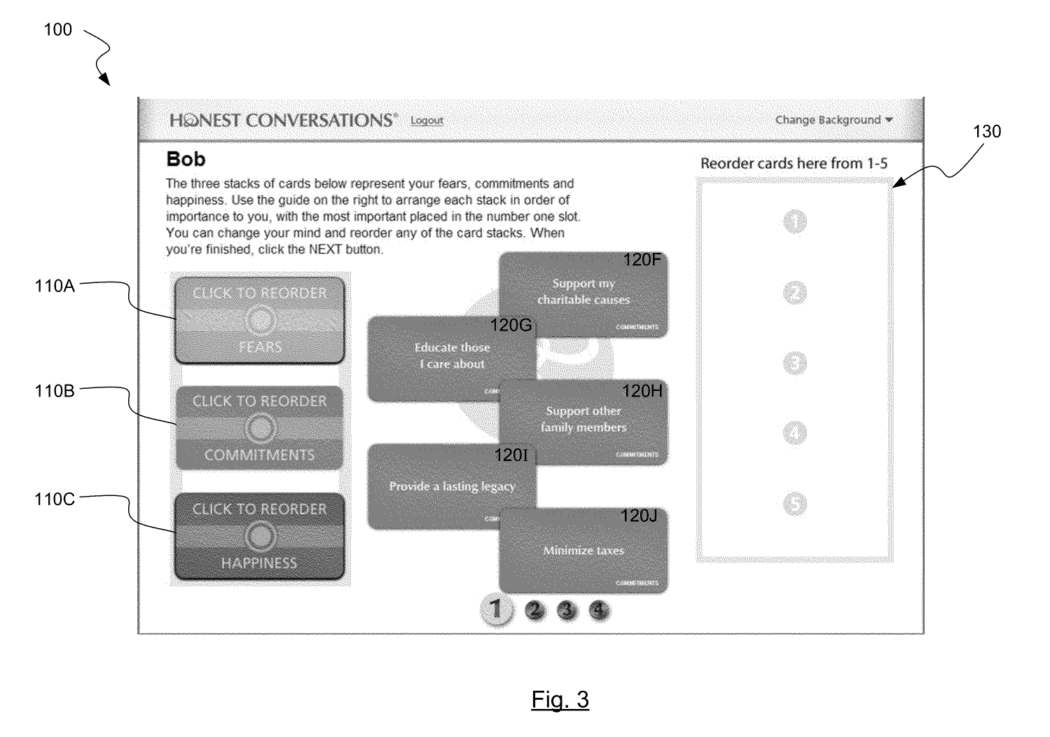

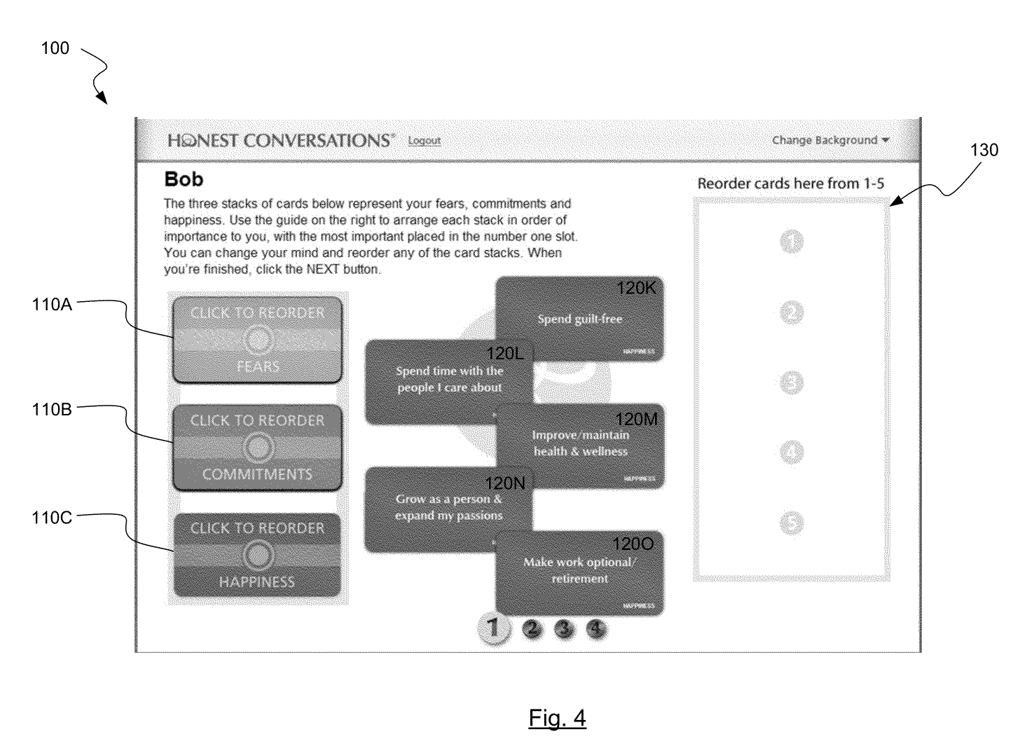

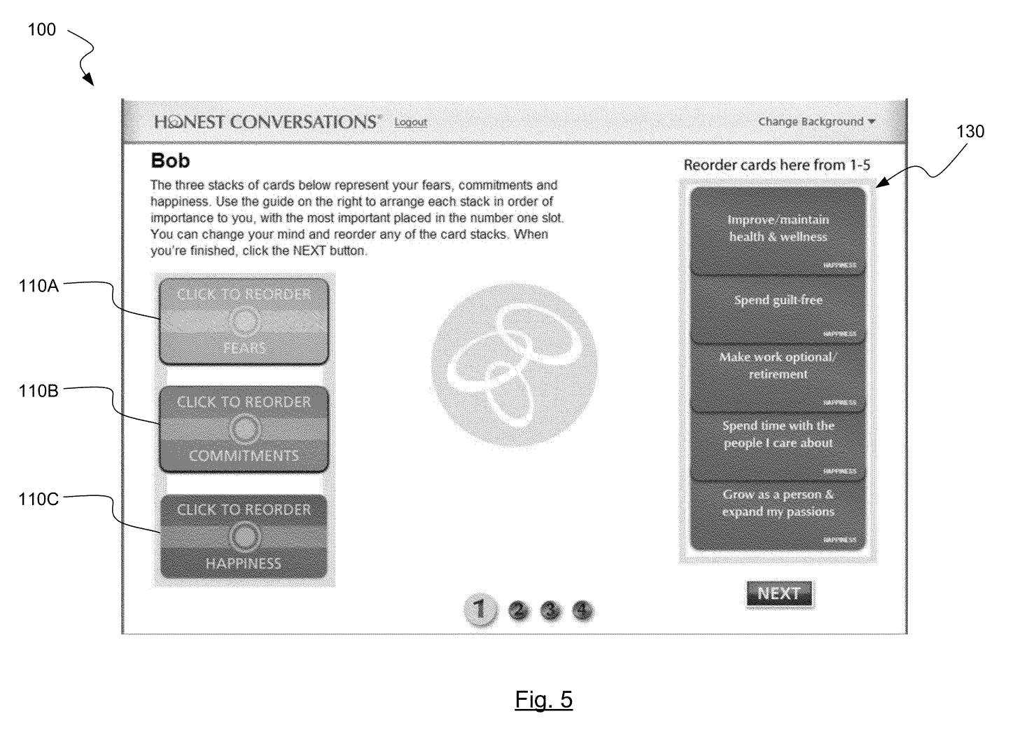

First interface 100 may receive from the first user a selection of one of categories 110 and then display a plurality of concerns 120 associated with the selected category 110, as shown in FIG. 2 after the user has selected a category. When an interface is discussed as “receiving” an input from a user herein, this should be understood as an input device of the interface receiving the initial user input. Thereafter, a visual device of the interface may possibly display a consequence of the input so received. The input device may be a mouse, keyboard, touch screen, or some other device. FIG. 2 shows “fears” category 110A expanded, and each of its concerns 120 viewable. FIG. 3 and FIG. 4 show the same for “commitments” category 110B and “happiness” category 110C.

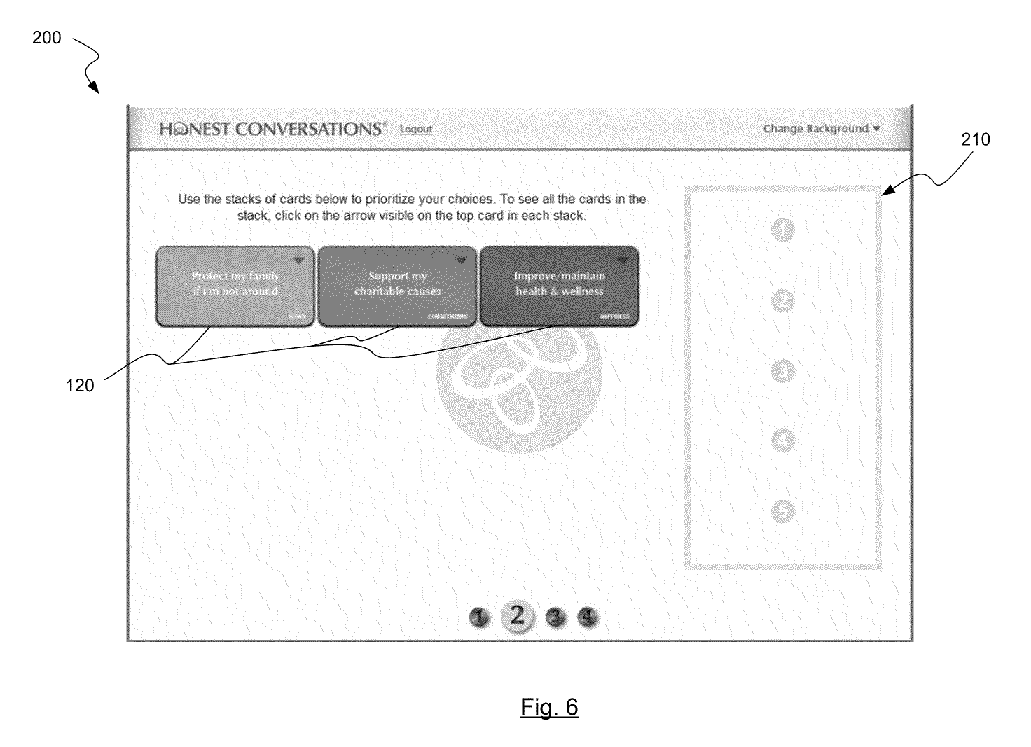

First interface 100 may then receive from the first user a selection of one or more of the concerns 120 and allow the first user to input a priority of these concerns 120 from most important to least important. As shown in FIG. 5, a user may drag-and-drop the “cards” representing each of concerns 120 into a queue area 130 on the right side of first interface 100 in order of their importance or priority. In this example, the top-most card is the most important to or top priority of the first user. The cards, even once located in queue area 130, may be rearranged. The user's progress on prioritizing the cards may be continually stored by first interface 100 so that they may be later recalled by an interface. When an interface is discussed as “saving” or “storing” information, this should be understood as a storage medium associated with the interface storing such information. In this manner, first interface 100 may allow the first user to select the remaining categories 110, or navigate back and forth between categories 110, and repeat the selection and prioritization process for each category 110. A user may select as few as one concern 120 in each category 110, where that one concern 120 is the user's only priority in that category 110, or the user may select all of the concerns 120 in a category 110 for prioritization.

Categories 110 and concerns 120 shown in FIGS. 2-4 are merely exemplary, and in other embodiments a fewer or greater number of categories 110 could be present, and each category 110 could include a fewer or greater number of concerns 120 therein. Each category 110 could also have the same or different number of concerns 120 as other categories 110.

In the example shown in FIGS. 2-4, there are three categories 110, with each category 110 having five potential user concerns 120. The “fears” category 110A may include the following concerns 120: “Protect my family if I'm not around” 120A, “Not being a burden to my family” 120B, “Prepare for the unexpected” 120C, “Protect my lifestyle” 120D, and “Income security/safety net” 120E. The “commitments” category 110B may include the following concerns 120: “Support my charitable causes” 120F, “Educate those I care about” 120G, “Support other family members” 120H, “Provide a lasting legacy” 120I, and “Minimize taxes” 120J. The “happiness” category 110C may include the following concerns 120: “Spend guilt-free” 120K, “Spend time with the people I care about” 120L, “Improve/maintain health and wellness” 120M, “Grow as a person and expand my passions” 120N, and “Make work optional/retirement” 120O.

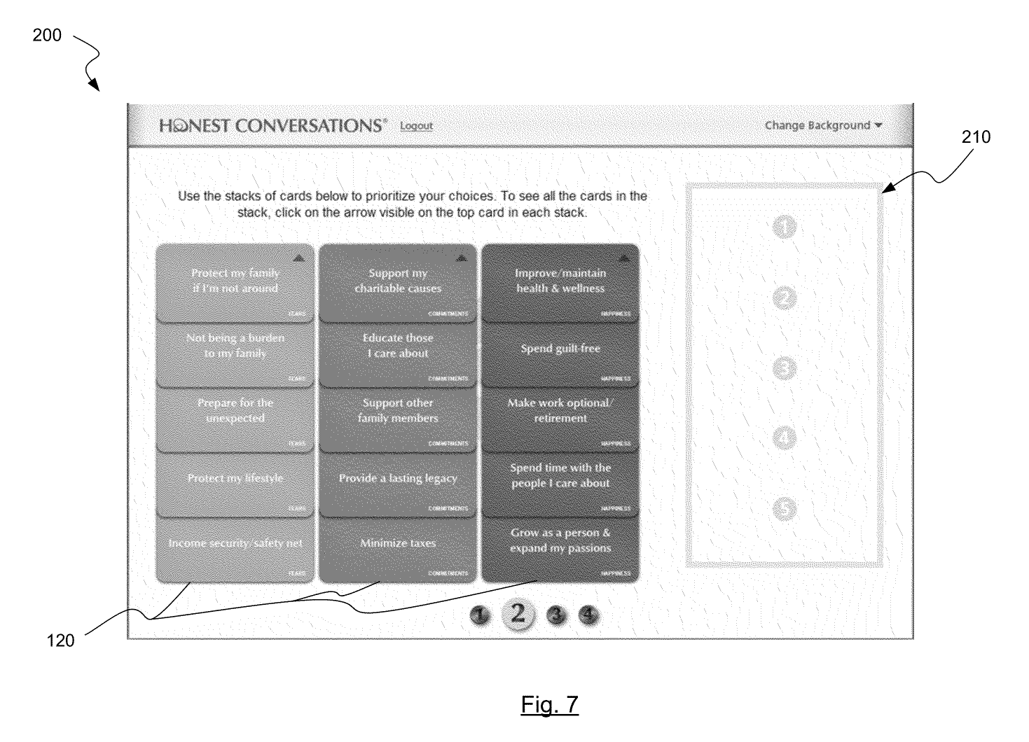

Once the user has used first interface 100 to sort all the concerns 120 they selected in categories 110, a second interface 200 may be presented to the user as shown in FIG. 6. Second interface 200 may display the top priority concern 120 from each category 110. The user may be allowed to expand each category 110 to see the entire prioritization of that category 110 by providing an instructional input to second interface 200, as shown in FIG. 7, where all categories 110 are shown expanded.

The user may then use second interface 200 to sort the cards from all three categories 110 into an overall priority using a drag-and-drop process as with first interface 100. The prioritized presentation of each category 110 allows for a simpler process to reach an overall priority of concerns 120 across all categories than would be possible if all concerns 120 were presented to the user at once. In the manner shown by second interface 200, only the top priority concern 120 from each category 110 are presented at any given time, meaning the user has to only select from three possible concerns 120 rather than fifteen concerns 120. Similar advantages would be achieved for any number of possible categories 110 and concerns 120.

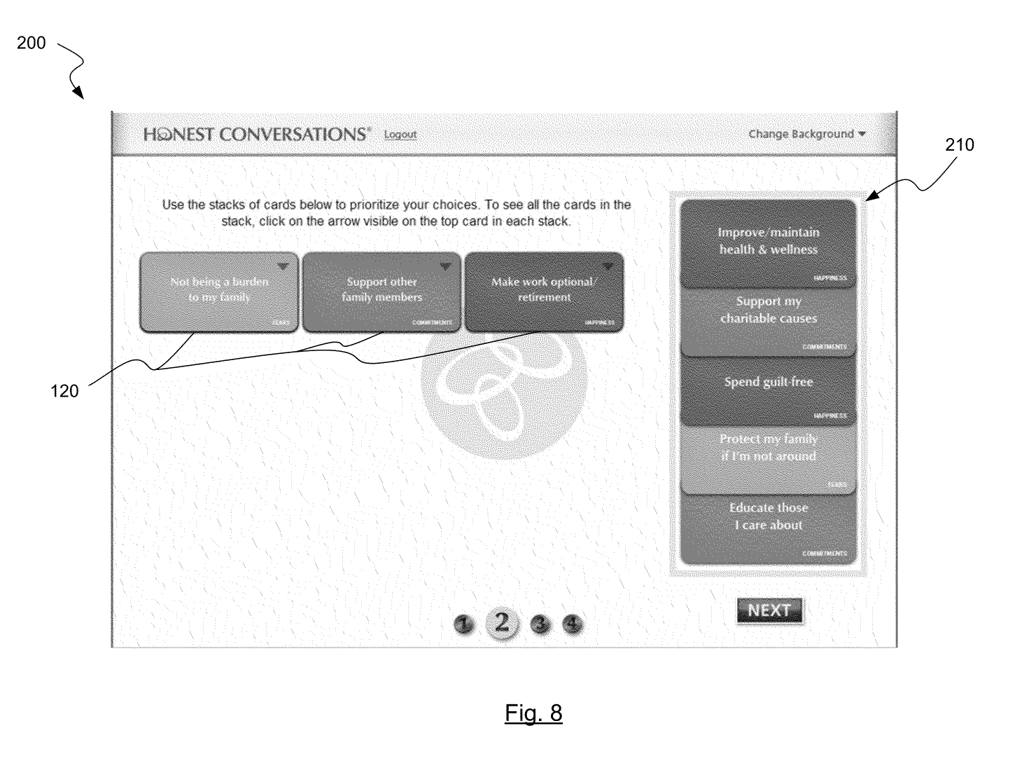

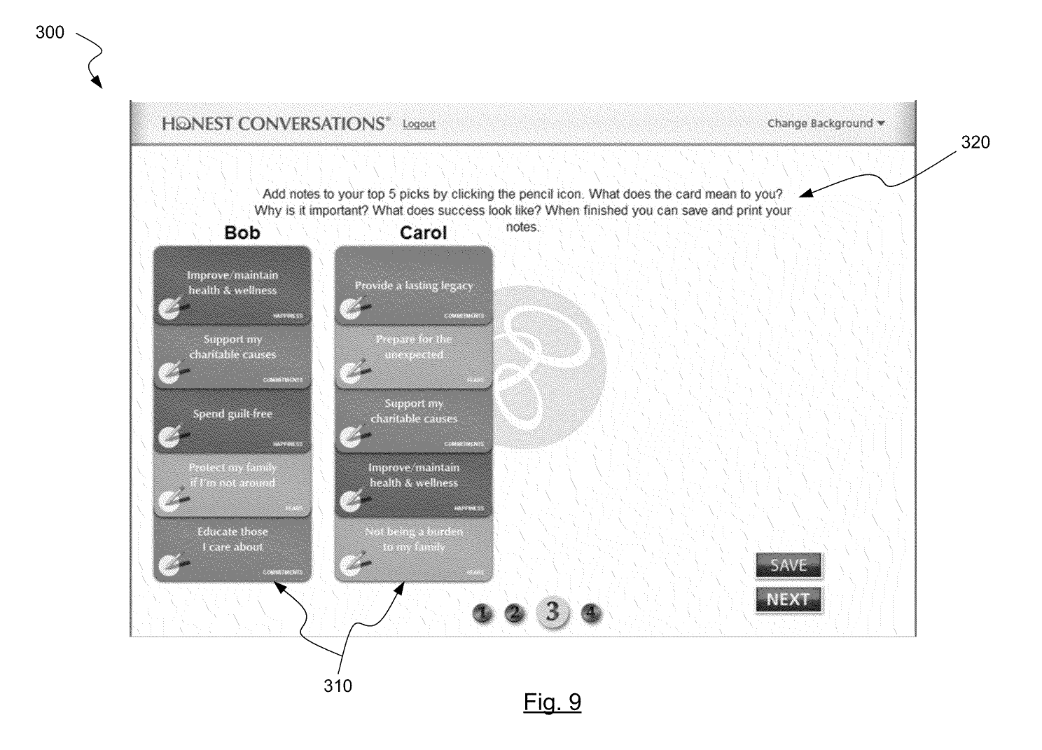

Turning to FIG. 8, as a top concern 120 from a particular category 110 is moved to a queue area 210 of interface on the right by the user, the next top concern 120 from that particular category 110 is revealed. This occurs until the user has filled queue area 210 on the right side of the interface. If a user desires, they may drag a card from the queue area 210 back to the original stacks, and select another card. This may include expanding each stack and selecting a card out of the previously saved prioritization order.

Once the user completes the process in second interface 200, that user has completed the individual portion of prioritization. If the financial/retirement/other planning for the individual involves a partner such as a wife or significant other, the process may be repeated for the other user using a third and fourth interface similar to, or the same as, first interface 100 and second interface 200, respectively. This interface may be provided separately, so that it is only viewed/accessed by the particular user providing input.

In this manner, each user may prioritize the concerns on their own, without the presence or input, and perhaps consequently, pressure or bias from the other user to prioritize concerns in a certain fashion. This may be particularly important in a husband/wife or partner/partner situation, where honest input is desired from each individual. Thus, a voice is provided to each user, so that the concerns of each individual may be addressed by a third party/adviser, and any fiduciary duty to each party owed by the third party/adviser may be satisfied.

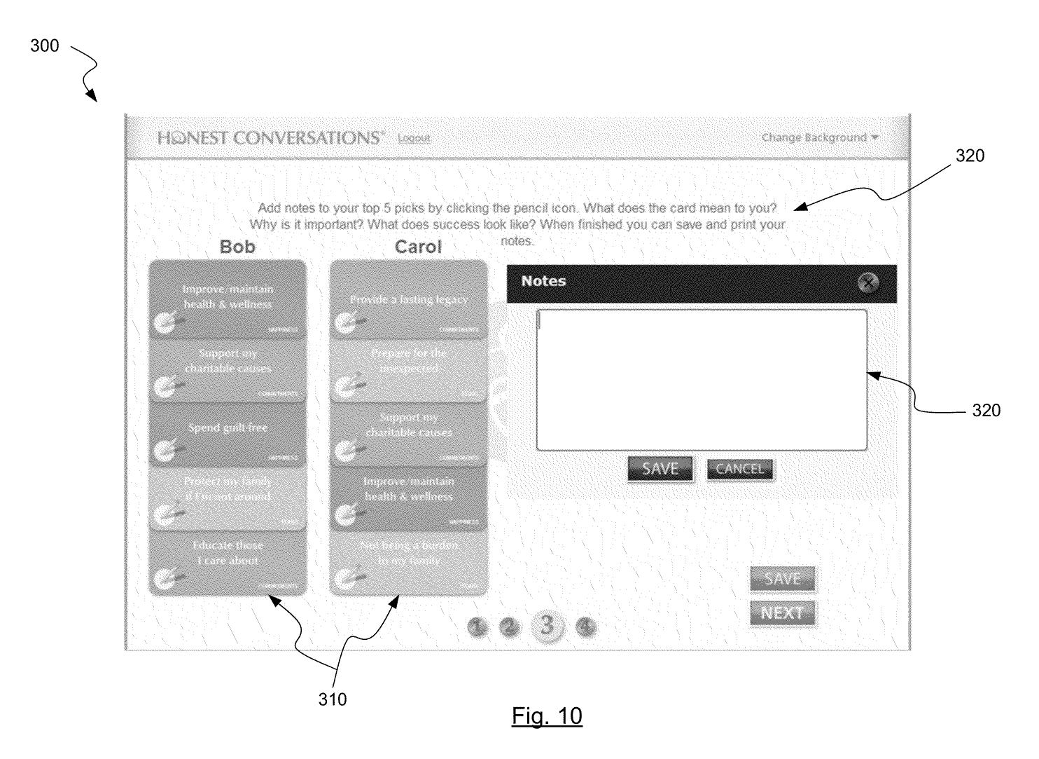

Turning to FIG. 9, a fifth interface 300 may then be provided to display the prioritized overall concerns 310 from both the first user and the second user. Fifth interface 300 may allow either user or another party on behalf of the users to input and store notes regarding each concern 120 by clicking on a particular concern 120 so that an input query opens as shown in FIG. 10. In some embodiments, general questions may be presented by fifth interface 300 as shown in area 320 to prompt a user to provide meaningful input regarding the concern. In other embodiments, specific questions pertinent to particular concerns may be presented to the user through the interface when a particular concern is selected. Additionally, an adviser or other third party to the users may have at their disposal additional questions pertinent to particular concerns they could ask the users. The adviser may be a person trained and/or certified to conduct this “interview” with the user. In yet another embodiment, another, separate and different interface may automatically provide these questions to an adviser in response to selection of any concern by a user throughout the processes discussed herein. In some embodiments, this interface could be presented on a separate device from that being used by the users. This separate interface could also be used to collect notes/information from the third party/adviser as received from the users.

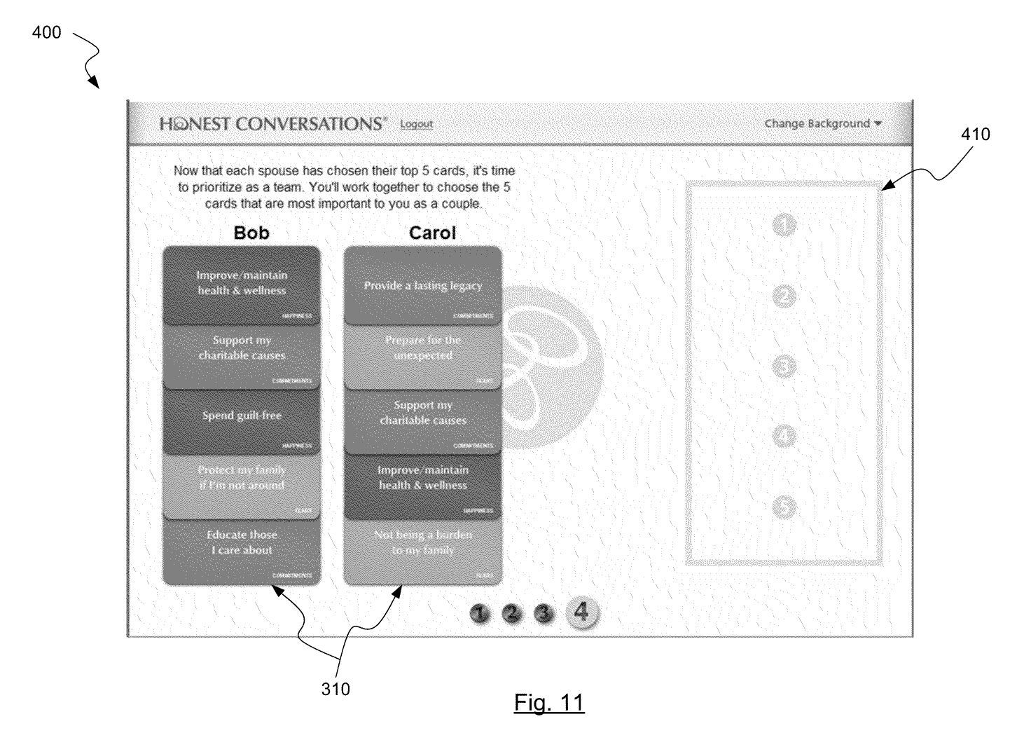

After users are finished inputting notes into fifth interface 300, a sixth interface 400 may be provided as shown in FIG. 11. The prioritized overall concerns 310 are again displayed, and both the first user and the second user may together collaborate to prioritize their joint concerns into queue area 410. The selected and prioritized concerns may be clicked and dragged from the left side to the right side of sixth interface 400, and reorganized as desired by the users. Though five slots are shown in queue area 410 of sixth interface 400, fewer or greater concerns may be prioritized depending on the embodiment and/or the desires of the users.

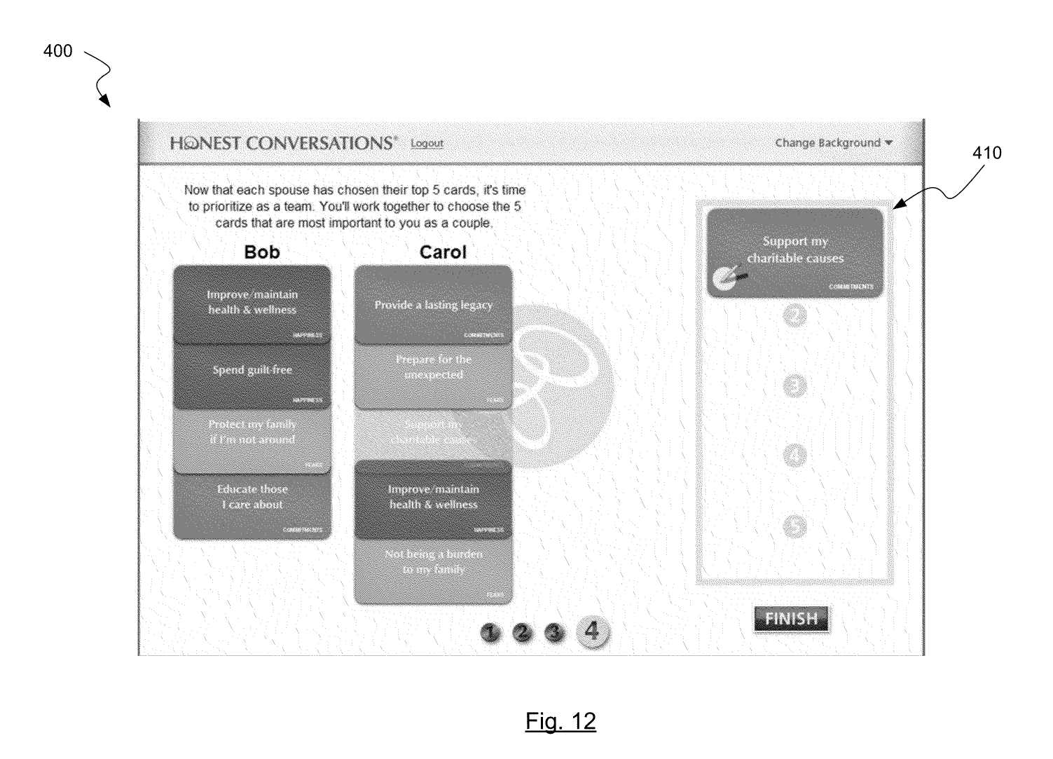

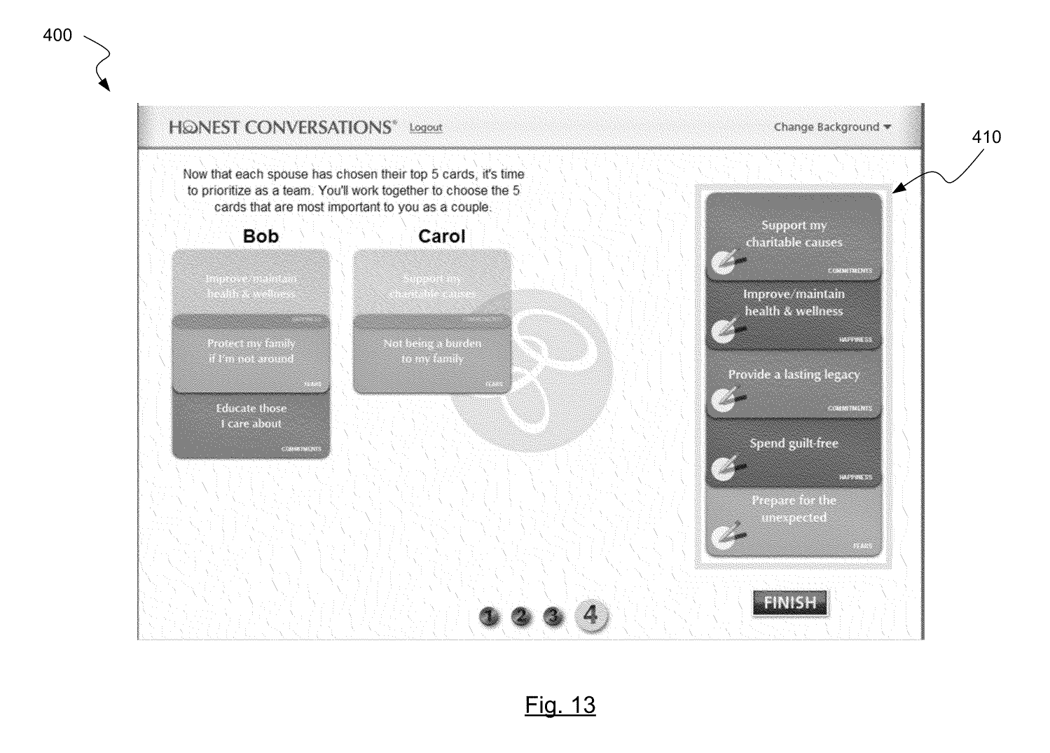

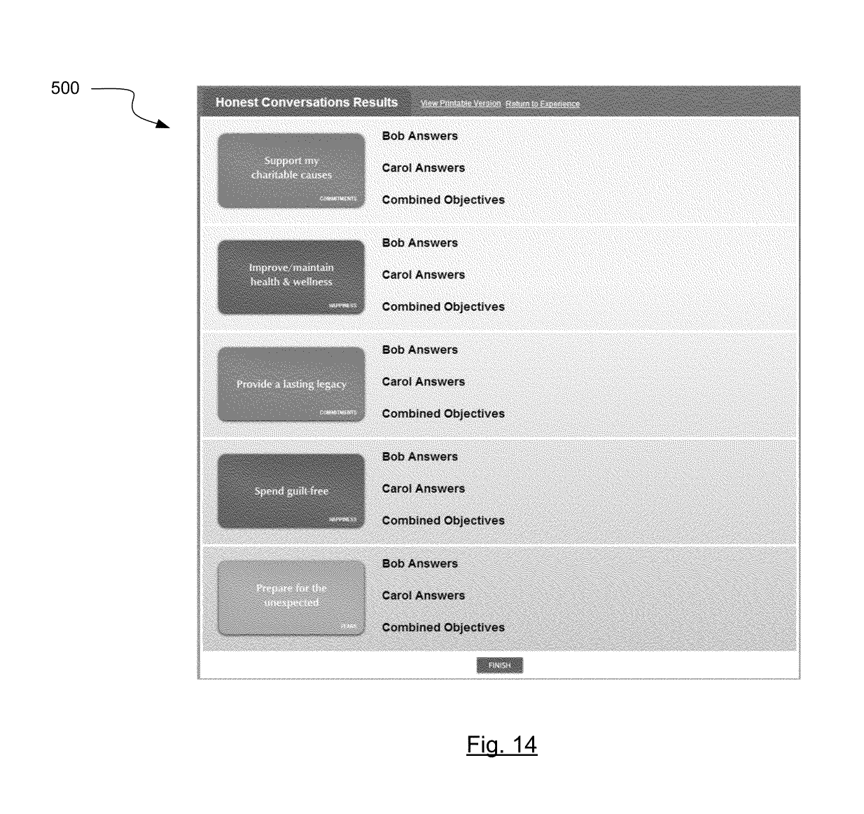

FIG. 12 shows sixth interface 400 when one of the concerns has been selected from the priorities of the first user. That concern, here “Support my charitable causes,” has been moved by the users from the individual prioritized concerns to the overall prioritized concerns of queue area 410. The concern, if it exists in the other user's individual prioritized concerns is then grayed out, or otherwise indicated to have been previously selected/prioritized into the overall listing. FIG. 13 shows the end result after the two users have prioritized their joint concerns. Finally, FIG. 14 shows a display 500 of the collection of notes/answers that either both users have provided regarding the selected/prioritized concerns. This information may be shown on an additional seventh interface. Furthermore, an electronic or paper report including this information may be produced and provided to any particular user and/or third party/adviser. Additional information, including recommendations, advice, or other data may be added to this report by the third party/adviser.

In the above manner then, only after each user has prioritized their own concerns, will both users work together to prioritize their concerns jointly. Concerns prioritized by either user may provide insight to the other user, perhaps even surprising them. This interaction opens up communication between the parties and may allow them to work better together to satisfy that not only their joint concerns will be addressed by a future planned course of action, but that their individual concerns will also be addressed by that course of action.

In another embodiment of the invention, the above systems and processes may be implemented through the manual use of physical cards having the categories and concerns discussed above. Merely by way of example, a matching deck of cards may be provided to each of the two users, and the users may use the matching decks as described above to achieve substantially similar results. As with the previously described systems and processes, different numbers of categories and concerns/statements are possible.

In such a deck of cards, each of the cards may have the same generally rectangular shape and size. Thus, while the overall dimensions may be rectangular, curved corners and edges may be present in such generally rectangular card. These cards may be substantially similar to those shown in the figures via the various interfaces previously discussed.

Each card may have a first side and a second side, and the first side of each card may include indicia thereon representative of a category. A plurality of categories may be represented in the deck of cards. A second side of each card may include indicia thereon which includes a statement, where each statement on a second side of a particular card is associated with the category indicated on the first side of the particular card.

The plurality of categories may, in some embodiments, include the following categories: “Fears”, “Commitments”, and “Happiness”. In some embodiments, each of the categories may have their own particular coloring/decorative scheme, where each card in that category uses the same scheme. In embodiments, Braille card, or cards including Braille indicia may be provided.

The plurality of cards having the indicia representative of the “Fears” category on the first side may, in some embodiments, include cards have the following statements on their respective second sides: “Income security/safety net”, “Not being a burden to my family”, “Prepare for the unexpected”, “Protect my family if I'm not around”, and “Protect my lifestyle”. The plurality of cards having the indicia representative of the “Commitments” category on the first side may, in some embodiments, include cards have the following statements on their respective second sides: “Educate those I care about”, “Minimize taxes”, “Provide a lasting legacy”, “Support my charitable causes”, and “Support other family members”. The plurality of cards having the indicia representative of the “Happiness” category on the first side may, in some embodiments, include cards have the following statements on their respective second sides: “Grow as a person and expand my passions”, “Improve/maintain health and wellness”, “Make work optional/retirement”, “Spend guilt-free”, and “Spend time with the people I care about”.

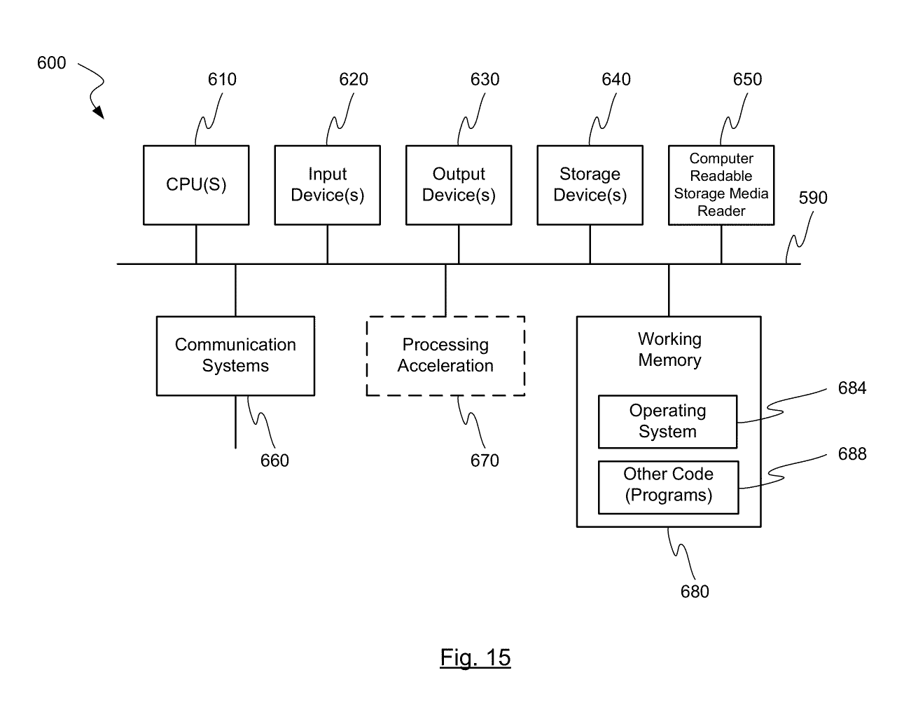

FIG. 15 is a block diagram illustrating an exemplary computer system 600 in which embodiments of the present invention may be implemented. This example illustrates a computer system 600 such as may be used, in whole, in part, or with various modifications, to provide the functions of the various interfaces, and/or other components of the invention such as those discussed above. For example, various functions of the first interface may be controlled by the computer system 600, including, merely by way of example, selection of a category, selection of a concern/card/statement, prioritization thereof, etc.

The computer system 600 is shown comprising hardware elements that may be electrically coupled via a bus 690. The hardware elements may include one or more central processing units 610, one or more input devices 620 (e.g., a mouse, a keyboard, etc.), and one or more output devices 630 (e.g., a display device, a printer, etc.). The computer system 600 may also include one or more storage device 640. By way of example, storage device(s) 640 may be disk drives, optical storage devices, solid-state storage device such as a random access memory (“RAM”) and/or a read-only memory (“ROM”), which can be programmable, flash-updateable and/or the like.

The computer system 600 may additionally include a computer-readable storage media reader 650, a communications system 660 (e.g., a modem, a network card (wireless or wired), an infra-red communication device, Bluetooth™ device, cellular communication device, etc.), and working memory 680, which may include RAM and ROM devices as described above. In some embodiments, the computer system 600 may also include a processing acceleration unit 670, which can include a digital signal processor, a special-purpose processor and/or the like.

The computer-readable storage media reader 650 can further be connected to a computer-readable storage medium, together (and, optionally, in combination with storage device(s) 640) comprehensively representing remote, local, fixed, and/or removable storage devices plus storage media for temporarily and/or more permanently containing computer-readable information. The communications system 660 may permit data to be exchanged with a network, system, computer and/or other component described above.

The term “machine-readable medium” includes, but is not limited to transitory and/or non-transitory mediums, portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The computer system 600 may also comprise software elements, shown as being currently located within a working memory 680, including an operating system 684 and/or other code 688. It should be appreciated that alternate embodiments of a computer system 600 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 600 may include code 688 for implementing any or all of the function of the various elements of the architecture as described herein. For example, software, stored on and/or executed by a computer system such as system 600, can provide the functions of the various interfaces, and/or other components of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A system for receiving input from a user or users, the input indicating the relative priorities of different concerns, wherein the system comprises:
a first interface configured to:
display, to a first user, a plurality of categories of concerns, wherein the categories of concerns comprise:
a “Fears” category;
a “Commitments” category; and
a “Happiness” category;
receive, from the first user, a selection of the “Fears” category;
display, to the first user, in response to the selection of the “Fears” category, a plurality of “Fears” concerns, including:
“Income security/safety net”;
“Not being a burden to my family”;
“Prepare for the unexpected”;
“Protect my family if I'm not around”; and
“Protect my lifestyle”;
receive, from the first user:
a selection of at least one of the plurality of “Fears” concerns; and
a prioritization of the selected at least one of the plurality of “Fears” concerns if more than one was selected by the first user;
receive, from the first user, a selection of the “Commitments” category;
display, to the first user, in response to the selection of the “Commitments” category, a plurality of “Commitments” concerns, including:
“Educate those I care about”;
“Minimize taxes”;
“Provide a lasting legacy”;
“Support my charitable causes”; and
“Support other family members”;
receive, from the first user:
a selection of at least one of the plurality of “Commitments” concerns; and
a prioritization of the selected at least one of the plurality of “Commitments” concerns if more than one was selected by the first user;
receive, from the first user, a selection of the “Happiness” category;
display, to the first user, in response to the selection of the “Happiness” category, a plurality of “Happiness” concerns, including:
“Grow as a person and expand my passions”;
“Improve/maintain health and wellness”;
“Make work optional/retirement”;
“Spend guilt-free”; and
“Spend time with the people I care about”; and
receive, from the first user:
a selection of at least one of the plurality of “Happiness” concerns; and
a prioritization of the selected at least one of the plurality of “Happiness” concerns if more than one was selected by the first user; and
a second interface configured to:
display, to the first user, the selected concerns in each category in order of priority; and
receive, from the first user, a prioritization of the selected concerns.

2. The system for receiving input from a user or users, the input indicating the relative priorities of different concerns of claim 1, wherein the system further comprises:
a third interface configured to provide the same functionality as the first interface to a second user; and
a fourth interface configured to provide the same functionality as the second interface to the second user.

3. The system for receiving input from a user or users, the input indicating the relative priorities of different concerns of claim 2, wherein the system further comprises:
a fifth interface configured to receive notes from at least the first user or the second user regarding at least one of the selected concerns.

4. The system for receiving input from a user or users, the input indicating the relative priorities of different concerns of claim 2, wherein the system further comprises:
a fifth interface configured to:
display to the first user and the second user the selected concerns of the first user in order of priority;
display to the first user and the second user, the selected concerns of the second user in order of priority; and
receive a prioritization of at least one selected concern from the selected concerns of the first user and the selected concerns of the second user.

5. The system for receiving input from a user or users, the input indicating the relative priorities of different concerns of claim 1, wherein the system further comprises:
a third interface configured to receive notes from the first user regarding at least one of the selected concerns.

6. The system for receiving input from a user or users, the input indicating the relative priorities of different concerns of claim 1, wherein the first interface is further configured to:
display feedback or questions to the first user based at least in part on selection by the first user of:
at least one of the plurality of “Fears” concerns;
at least one of the plurality of “Commitments” concerns; and
at least one of the plurality of “Happiness” concerns.

7. The system for receiving input from a user or users, the input indicating the relative priorities of different concerns of claim 2, wherein the third interface is further configured to:
display feedback or questions to the first user based at least in part on selection by the second user of:
at least one of the plurality of “Fears” concerns;
at least one of the plurality of “Commitments” concerns; and
at least one of the plurality of “Happiness” concerns.

8. The system for receiving input from a user or users, the input indicating the relative priorities of different concerns of claim 1, wherein the system further comprises:
a processor configured to:
determine a specific course of action to take with assets of the first user based on the prioritization of the selected concerns.

9. The system for receiving input from a user or users, the input indicating the relative priorities of different concerns of claim 4, wherein the system further comprises:
a processor configured to:
determine a specific course of action to take with assets of the first user and the second user based on the prioritization of at least one selected concern from the selected concerns of the first user and the selected concerns of the second user.

10. A non-transitory machine readable medium with instructions stored thereon for obtaining prioritized user input, the instructions executable by at least one processor to:
(a) display, to a first user, a plurality of categories;
(b) receive, from the first user, a selection of a particular category of the plurality of categories;
(c) display, to the first user, in response to the selection of the particular category, a plurality of statements associated with the particular category;
(d) receive, from the first user, a selection of at least one of the plurality of statements associated with the particular category;
(e) receive, from the first user, a prioritization of the selected at least one of the plurality of statements associated with the particular category if more than one was selected;
(f) repeat steps (b), (c), (d), and (e) for each of the plurality of categories;
(g) display, to the first user, the selected statements in each category in order of priority; and
(h) receive, from the first user, a prioritization of the selected statements.

11. The non-transitory machine readable medium with instructions stored thereon of claim 10, wherein the instructions are further executable by at least one processor to:
(i) repeat steps (a), (b), (c), (d), (e), (f), (g), and (h) for a second user.

12. The non-transitory machine readable medium with instructions stored thereon of claim 11, wherein the instructions are further executable by at least one processor to:
(j) display the selected statements of the first user in order of priority and the selected statements of the second user in order of priority.

13. The non-transitory machine readable medium with instructions stored thereon of claim 12, wherein the instructions are further executable by at least one processor to:
(k) receive notes from the first user or the second user, and associate the notes with at least one of the selected statements.

14. The non-transitory machine readable medium with instructions stored thereon of claim 12, wherein the instructions are further executable by at least one processor to:
(k) receive a prioritization of at least one of the selected statements of the first user and at least one of the selected statements of the second user.

15. The non-transitory machine readable medium with instructions stored thereon of claim 10, wherein:
the categories comprise:
“Fears”;
“Commitments”; and
“Happiness”;
the “Fears” category comprises at least the following statements:
“Income security/safety net”;
“Not being a burden to my family”;
“Prepare for the unexpected”;
“Protect my family if I'm not around”; and
“Protect my lifestyle”;
the “Commitments” category comprises at least the following statements:
“Educate those I care about”;
“Minimize taxes”;
“Provide a lasting legacy”;
“Support my charitable causes”; and
“Support other family members”; and
the “Happiness” category comprises at least the following statements:
“Grow as a person and expand my passions”;
“Improve/maintain health and wellness”;
“Make work optional/retirement”;
“Spend guilt-free”; and
“Spend time with the people I care about”.

16. A method of using cards having at least potential participant concerns reproduced thereon to identify and prioritize the concerns of at least one participant, wherein the method comprises:
(a) providing a plurality of cards, wherein:
each of the plurality of cards is characterized by a category; and
each of the plurality of cards has a potential participant concern reproduced thereon that is associated with the category of the particular card;
(b) a first participant arranging the cards in each category from highest actual priority concern of the first participant to lowest actual priority concern of the first participant;
(c) the first participant selecting a card having a top overall actual priority concern from the highest actual priority concern in each category; and
(d) the first participant repeating, at least once, step (c) from the remaining cards having a highest actual priority concern in each category to produce an ordered selection of cards having an overall priority of concerns across all categories.

17. The method of using cards having at least potential participant concerns reproduced thereon to identify and prioritize the concerns of at least one participant of claim 16, wherein the method further comprises:
(e) repeating steps (a), (b), (c), and (d) for a second participant with a second plurality of cards.

18. The method of using cards having at least potential participant concerns reproduced thereon to identify and prioritize the concerns of at least one participant of claim 17, wherein the method further comprises:
(f) the first participant and the second participant selecting and prioritizing cards from the ordered selection of cards from each participant.

19. The method of using cards having at least potential participant concerns reproduced thereon to identify and prioritize the concerns of at least one participant of claim 16, wherein the method further comprises:
(e) asking at least one question to the first participant based at least in part on selection by the first participant of a particular card.

20. The method of using cards having at least potential participant concerns reproduced thereon to identify and prioritize the concerns of at least one participant of claim 17, wherein the method further comprises:
(f) asking at least one question to the second participant based at least in part on selection by the second participant of a particular card.

21. A deck of cards, each of the cards having the same generally rectangular shape and size, and comprising a first side and a second side, wherein:
the first side of each card comprises indicia thereon representative of a category, wherein a plurality of categories are represented in the deck of cards;
the second side of each card comprises indicia thereon which includes a statement, wherein each statement on a second side of a particular card is associated with the category indicated on the first side of the particular card.

22. The deck of cards of claim 21, wherein the plurality of categories comprises the following categories:
“Fears”;
“Commitments”; and
“Happiness”.

23. The deck of cards of claim 22, wherein the plurality of cards having the indicia representative of the “Fears” category on the first side include cards have the following statements on their respective second sides:
“Income security/safety net”;
“Not being a burden to my family”;
“Prepare for the unexpected”;
“Protect my family if I'm not around”; and
“Protect my lifestyle”.

24. The deck of cards of claim 22, wherein the plurality of cards having the indicia representative of the “Commitments” category on the first side include cards have the following statements on their respective second sides:
“Educate those I care about”;
“Minimize taxes”;
“Provide a lasting legacy”;
“Support my charitable causes”; and
“Support other family members”.

25. The deck of cards of claim 22, wherein the plurality of cards having the indicia representative of the “Happiness” category on the first side include cards have the following statements on their respective second sides:
“Grow as a person and expand my passions”;
“Improve/maintain health and wellness”;
“Make work optional/retirement”;
“Spend guilt-free”; and
“Spend time with the people I care about”.
